(19) United States
(12) Patent Application Publication
(10) Pub. No.: US 2010/0113164 A1
(43) Pub. Date: May 6, 2010

(54) TORQUE TRANSMISSION DEVICE FOR THE LOW VIBRATION TRANSMISSION OF TORQUE VIA AT LEAST ONE SHAFT

(75) Inventors: Joachim Rothe, Muhldorf (DE); Steffen Jerye, Haag (DE)

Correspondence Address: KOLISCH HARTWELL, P.C., 200 PACIFIC BUILDING, 520 SW YAMHILL STREET, PORTLAND, OR, 97204, US

(73) Assignee: SGF Suddeutsche Gelenkscheibenfabrik GmbH & Co., KG, Waldkraiburg (DE)

(21) Appl. No.: 12/304,116

(22) PCT Filed: May 15, 2007
(86) PCT No.: PCT/EP07/04326

§ 371 Date: Dec. 9, 2008

(30) Foreign Application Priority Data
Jun. 9, 2006 (DE) 10 2006 026 946.2
Sep. 29, 2006 (DE) 10 2006 046 459.1

(51) Int. Cl. F16D 3/14

(52) U.S. Cl. 464/73

(57) ABSTRACT

Torque transmission device 910 for the vibration-reduced transmission of torques via at least one shaft, having:
a drive element 912 and a driven element 914 connected to the drive element 912, there being formed between the drive element 912 and the driven element 914 at least one damping arrangement which connects the drive element 912 to the driven element 914 such that they can rotate relative to one another, the damping arrangement having a stepped progressive characteristic with increasing relative rotation between drive element 912 and driven element 914.

### FIELD OF THE INVENTION

The invention relates to a torque transmission device for the vibration-reduced transmission of torques via at least one shaft, having a drive element and a driven element connected to the drive element.

### BACKGROUND OF THE INVENTION

Torque transmission devices of the above-mentioned type are used, for example, in the drive train of a motor vehicle, such as, for example, between the cardan shaft and the gearbox, the drive shaft and the differential, as well as in the steering-column arrangement. In these devices, a torque is to be transmitted from one shaft to another shaft as far as possible without losses. However, with such a direct coupling of the two shafts, vibrations and torsional vibrations which may occur are inadequately damped, leading to audible noises in the passenger compartment of the motor vehicle. For this reason, torque transmission devices are provided with damping elements which are intended to compensate for such vibrations and torsional vibrations. For example, a cylindrically designed rubber-elastic damping segment may be provided between the drive element and the driven element, this segment being fitted in between the drive element and the driven element.

It is an object of the present invention to provide a torque transmission device, the damping properties of which can be improved and specifically matched to the particular application.

### SUMMARY OF THE INVENTION

To achieve the aforementioned object, the invention provides a torque transmission device for the vibration-reduced transmission of torques via at least one shaft, having a drive element and a driven element connected to the drive element, there being formed between the drive element and the driven element at least one damping arrangement which connects the drive element to the driven element such that they can rotate relative to one another, the damping arrangement having a stepped progressive characteristic with increasing relative rotation between drive element and driven element.

By designing the damping arrangement with a stepped progressive characteristic, the effect achieved is that torsional vibrations are reliably damped in a normal operating range of moderate torque transmission. However, if a transmission of very large torques occurs, the characteristic takes a steep course until finally the torque is transmitted directly without further vibration damping.

A development of the invention provides that the drive element has a stop formation and that the driven element has a complementary counter stop formation, the stop formation and the counter stop formation engaging one in the other with mutual radial play and rotational play. The effect achieved by this is that firstly, in the normal operating range of moderate torque transmission, the rotational play of stop formation and counter stop formation is traversed while utilising a vibration-damping action. However, as soon as the rotational play is substantially completely used up, a direct torque transmission from the drive element to the driven element results. The stop formation and the counter stop formation may be formed on the drive element and on the driven element by primary shaping, or forming. For example, drive elements and driven elements of tubular design can be provided with a corresponding stop formation and counter stop formation, respectively, by roll forming.

In an advantageous embodiment of the invention, provision may be made, in this connection, for the stop formation and the counter stop formation to be designed in the form of a splining with play. As an alternative to this, provision may furthermore be made for the stop formation and the counter stop formation to be designed in the form of a polygonal form-fitting connection with play. In both cases, an intermediate space which provides the required rotational play is formed in each case between the stop formation and the counter stop formation.

A development of the invention provides that a compressible damping layer made of rubber material is provided between the stop formation and the counter stop formation. In order to achieve a specific dynamic behaviour of this damping layer, a development of the invention provides that a thread insert is embedded in the rubber layer, the insert counteracting an excessive deformation. In addition to or as an alternative to this, provision may also be made for a metal insert to be embedded in the rubber layer. Thread insert or metal insert each contribute to the progressivity.

According to a further variant of the invention, the stepped progressive characteristic of the torque transmission device according to the invention can be achieved in that at least one rubber-elastic pre-damper body is provided between the drive element and the driven element outside the cooperating stop formation and counter stop formation, which body connects the drive element to the driven body in a torsional-vibration-damping manner. In this embodiment variant, it is provided that firstly the pre-damper body is deformed in a vibration-reducing manner, since this body is designed with a low stiffness. During the deformation of the pre-damper body, a rotational play is used up between the stop formation and the counter stop formation. When this play has been used up, the stop formation and the counter stop formation cooperate in a torque-transmitting manner—optionally with interposition of a further damping layer provided between them.

A development of the invention provides that an intermediate element is arranged between the drive element and the driven element, the intermediate element being of tubular design and connected to the drive element and the driven element with respective interposition of a damping arrangement. This means that, in this embodiment variant, the drive element and the driven element are not directly coupled to one another, but with interposition of the intermediate element.

In the embodiment variant with intermediate element, provision may furthermore be made for the intermediate element to be connected, one behind the other when seen in the axial direction, to the drive element and the driven element, the drive element not overlapping the driven element. A spatially serial arrangement is thus involved here. As an alternative to this, the components drive element, driven element and intermediate element may, however, also overlap in the axial direction in order to save constructional space.

With regard to an arrangement with intermediate element, a development of the invention provides that the drive element or/and the driven element have a stop formation and that the intermediate element has a complementary counter stop formation in its respective region cooperating with the drive element and the driven element, the stop formation and the counter stop formation each engaging one in the other with mutual radial play and rotational play. Furthermore, in this connection, provision may be made according to the invention for the intermediate element to be of tubular design and to receive the drive element at one end and the driven element at the other end.

In arrangements which have toothings or the like, the problem which often arises is that, on dynamic stressing of such toothings, undesired toothing noises occur due to an interaction of surfaces coming into contact with one another. These noises then propagate in a vehicle and may be felt to be unpleasant by occupants in the passenger compartment. In order to counteract the occurrence of these noises, a development of the invention provides that a perforated rubber body for damping structure-borne noise is received in the drive element or/and in the driven element or/and in the intermediate element. At the boundary surfaces of the perforations of the rubber body, the noise is refracted and partially reflected. This results in interference and a substantial noise damping.

According to the invention, provision may be made for one component of drive element and driven element to be designed for attachment to a shaft end and for the other component of drive element and driven element to be designed for attachment to a jointed tube or to a homokinetic joint or to a universal joint. The respective interface to the shaft end is designed in accordance with the particular application.

A further embodiment variant of the invention provides that a rubber-elastic damping layer is provided between the drive element and the driven element and connects the drive element to the driven element, rolling contact bodies being embedded in the damping layer. In this case, provision may be made according to the invention for the rubber-elastic damping layer to provide, in the region of the rolling contact bodies, a play in relation to the respective rolling contact body when seen in the circumferential direction of the torque transmission device. In operation, with this solution, firstly the rubber-elastic damping layer is deformed with relatively little resistance, until the rolling contact bodies come to bear against the boundary surfaces of the rubber-elastic damping layer which define the play. A jump in the characteristic then takes place. Any further deformation can only be achieved under considerably greater resistance, since the rolling contact bodies roll against the boundary surfaces and deform the rubber-elastic damping layer under surface pressure. In this way, too, a stepped progressive characteristic can be achieved.

In modern vehicle manufacturing, increasing importance is also attached to a controlled behaviour in the event of a crash. In this connection, therefore, it is attempted to design the drive train to be capable of telescoping or collapsing. This means that the drive train can axially shorten as a result of a predetermined axial minimum loading which acts on the drive train in principle only in an accident situation, for example because the engine block is displaced rearwards in the vehicle owing to a head-on collision. In order to assist this, a development of the invention provides that the drive element and the driven element are capable of telescoping in the axial direction with respect to one another when a predetermined axial force is exceeded. As a result, an undesired buckling in the region of the torque transmission device according to the invention can be prevented.

### BRIEF DESCRIPTION OF THE FIGURES

The invention is described below by way of example with regard to a plurality of embodiments on the basis of the accompanying figures, in which:

FIG. 1 shows a longitudinal sectional view of a torque transmission device according to the invention along the section line I-I from FIG. 2;

FIG. 2 shows a side view from the left of FIG. 1;

FIG. 3 shows a second embodiment according to the invention of a torque transmission device according to the invention in a longitudinal sectional view;

FIG. 4 shows the second embodiment according to the invention in a side view from the left;

FIG. 5 shows a third embodiment of a torque transmission device according to the invention in a sectional view along the section line V-V from FIG. 6;

FIG. 6 shows a side view of the torque transmission device according to FIG. 5 from the left;

FIG. 7 shows a fourth embodiment of the torque transmission device according to the invention in a sectional view along the section line VII-VII from FIG. 8;

FIG. 8 shows a side view of the embodiment according to FIG. 7 from the left;

FIG. 9 shows a further embodiment according to the invention of the torque transmission device in a sectional view along the section line IX-IX according to FIG. 10;

FIG. 10 shows a side view of the torque transmission device according to FIG. 9 from the left;

FIG. 11 shows a sectional view of a further torque transmission device according to the invention along the section line XI-XI from FIG. 12;

FIG. 12 shows a side view from the left of the torque transmission device according to FIG. 11;

FIG. 13 shows a sectional view along the section line XIII-XIII from FIG. 14;

FIG. 14 shows the further torque transmission device according to the invention of FIG. 13 in a side view from the left;

FIG. 15 shows a further torque transmission device according to the invention in the axis-containing longitudinal section along the section line XV-XV from FIG. 16;

FIG. 16 shows a side view from the left of FIG. 15;

FIG. 17 shows a further embodiment of a torque transmission device according to the invention in the axis-containing longitudinal section along the section line XVII-XVII according to FIG. 18;

FIG. 18 shows the arrangement according to FIG. 17 in a side view from the left

FIGS. 19 to 30 show further embodiments of torque transmission devices according to the invention.

### DETAILED DESCRIPTION OF THE EXEMPLARY EMBODIMENTS

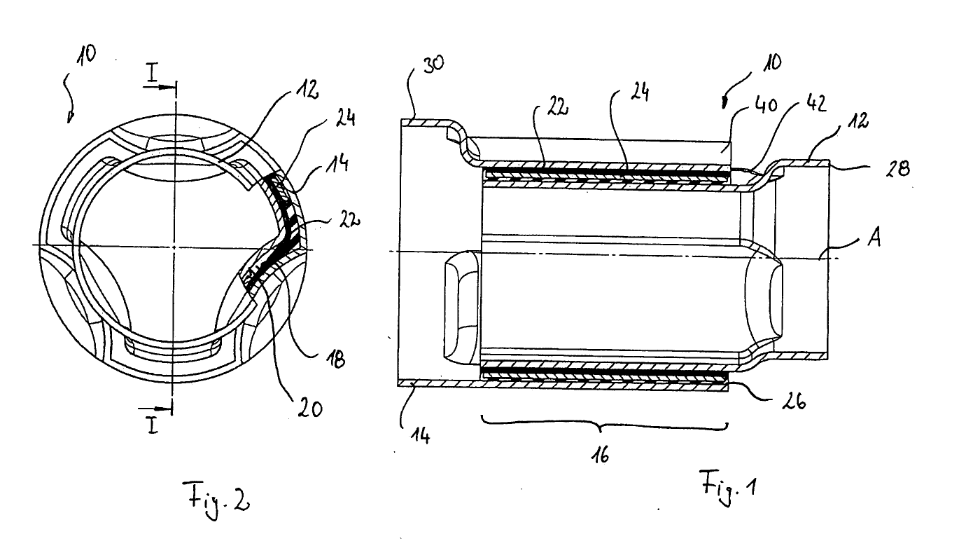

In FIG. 1 a torque transmission device according to the invention is shown in a longitudinal sectional illustration and is denoted generally by 10. This device comprises a tubular drive element 12 and a driven element 14 connected to the latter. The driven element 14 receives, in its right-hand region, the left-hand region of the drive element 12.

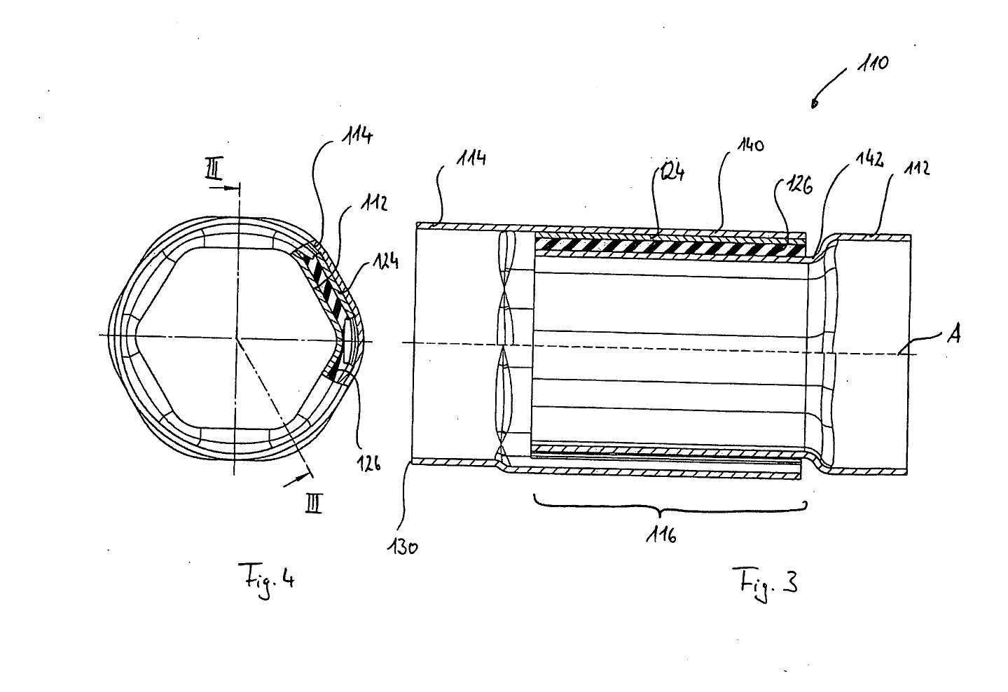

As can be seen in FIGS. 1 and 2, the drive element 12 and the driven element 14 are designed in a profited manner in their axial overlapping region 16 such that the drive element 12 exhibits stop surfaces 18 and that the driven element 14 exhibits corresponding counter stop surfaces 20. The stop surfaces 18 and counter stop surfaces 20 form a stop formation 40 and a counter stop formation 42 over the entire circumference of the drive element and of the driven element, respectively.

Between the stop surfaces 18 and the counter stop surfaces 20 there is formed a radial intermediate space, which is filled in the following manner. Firstly, this intermediate space contains a thread insert 22. In addition, individual metal strips 24 running in the axial direction are provided in the intermediate space. Both the thread insert 22 and the metal strips 24 are embedded in a rubber layer 26. The drive element 12 is thereby connected to the driven element in such a manner that the drive element can rotate relative to the driven element about the longitudinal axis A as a result of a torque transmission. This rotation takes place firstly under shear stressing of the rubber layer. With increasing relative rotation angle, however, the resistance increases progressively since the thread insert 22 counteracts any further rotation. The metal strips 24 also inhibit a further relative rotation. Finally, in the region of the stop surface 18 and the counter stop surface 20, the thread insert 22 and the rubber layer 26 are each compressed to such an extent that substantially no further yielding is possible. The further torque transmission takes place directly without any further relative rotation between drive element 12 and driven element 14.

As a result, torsional vibrations with progressive characteristic can be damped until finally, at a maximum relative rotation angle between drive element 12 and driven element 14, a direct torque transmission without further increase of the relative rotation angle occurs. It should be noted that the free ends 28 and 30 of the torque transmission device 10 according to the invention shown in FIGS. 1 and 2 can be used for coupling two shaft ends, in particular two shaft ends of a cardan shaft, which are attached preferably by welding on.

Furthermore, in FIG. 1 it can be seen that, when a sufficiently large axial force and a corresponding opposed force are applied to the drive element 12 and to the driven element 14, these two elements can be telescopically pushed one into the other, destroying the connection between drive element 12 and driven element 14 via the rubber layer 26. This is particularly advantageous in an accident situation, where, for example, a kind of collapsing of the drive train is desired. Particularly in cases where the engine block is pushed into the vehicle due to an accident, such a collapsing of the cardan shaft is desired in order to prevent uncontrolled buckling or a deformation of a different kind which takes up space.

FIG. 3 shows now a modification according to the invention. The same reference symbols are used as in FIG. 1, but prefixed with the numeral “1”.

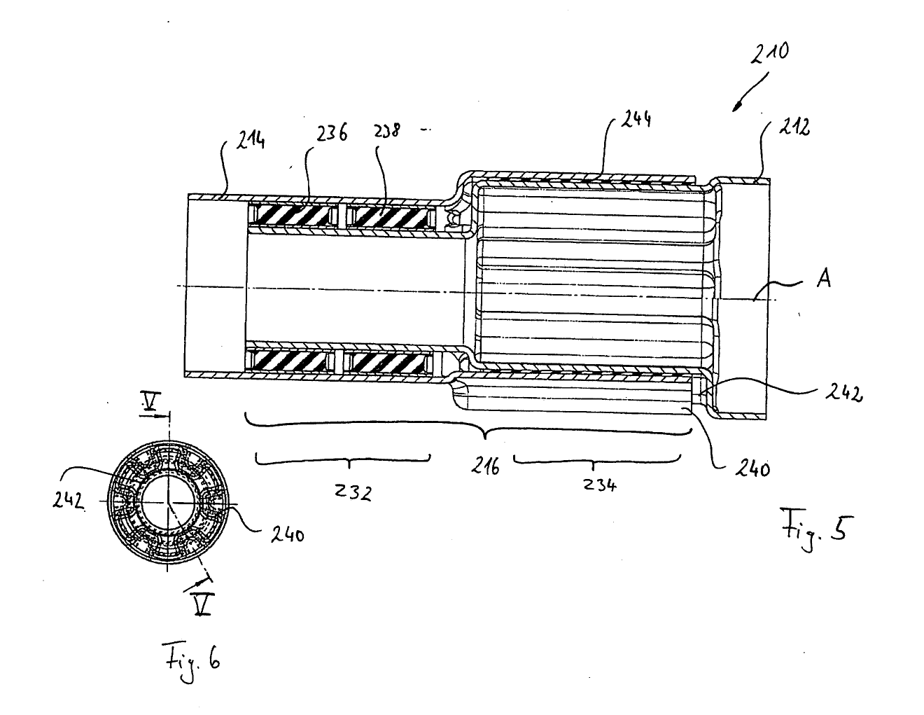

The embodiment according to FIGS. 3 and 4 differs from the embodiment according to FIGS. 1 and 2 essentially in that it contains no thread insert. The connection between the drive element 112 and the driven element 114 takes place solely by the rubber layer 126 and the metal strip 124. In addition, this embodiment differs from the first embodiment according to FIGS. 1 and 2 in that the stop formation 140 and the counter stop formation 142 is not realised by a kind of toothing as shown in FIGS. 1 and 2, but by two polygons, here hexagons, corresponding to one another, the mutually parallel surfaces of which are arranged spaced apart from one another, with the rubber layer 126 and the metal strip 124 being arranged between them.

The behaviour in operation, however, is similar to that already described above. Here, too, a relative rotation with progressive characteristic takes place until finally a state of maximum compression is reached in which substantially no further relative rotation is possible.

The arrangement according to FIGS. 3 and 4 can also be attached to a shaft for vibration reduction, for example, by welding to two shaft ends.

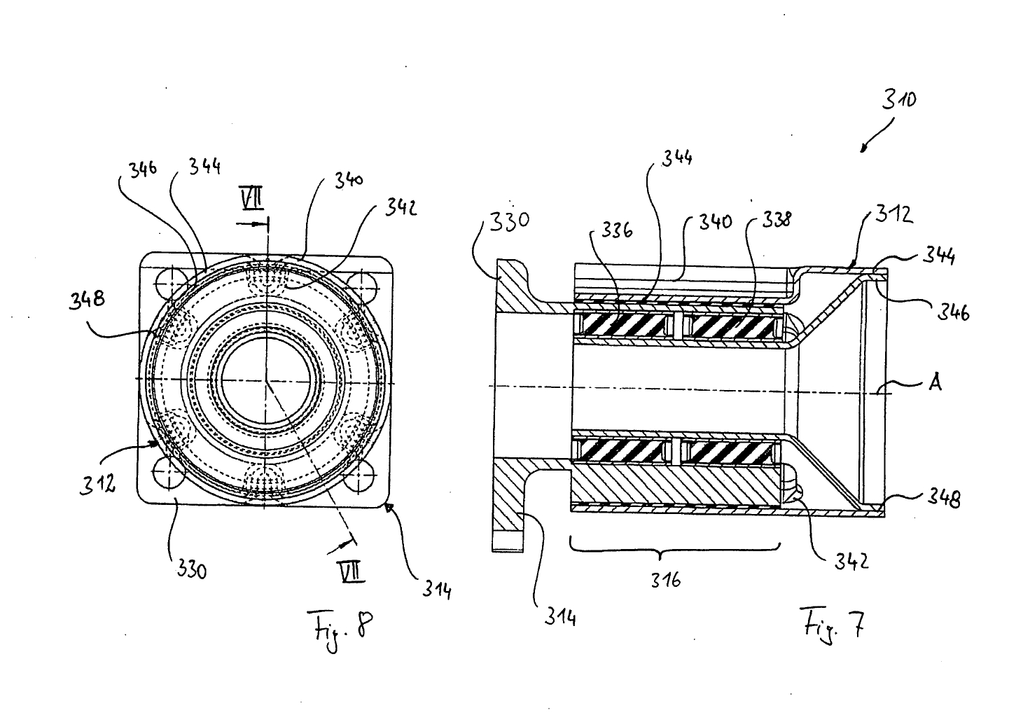

A further embodiment according to FIGS. 5 and 6 is again described using the same reference symbols, but prefixed with the numeral “2”. In this embodiment, the drive element 212 and the driven element 214 overlap in a larger axial region 216. This axial region 216 can be divided into a first axial sub-region 232 and a second axial sub-region 234. In the first axial sub-region 232, the drive element 212 and the driven element 214 are each of circular-cylindrical design. They are arranged at a considerable spacing from one another, that is to say they enclose a relatively wide annular gap with one another. In this annular gap there are fitted two rubber layers 236 and 238 which connect the drive element 212 to the driven element 214.

In the second axial sub-region 234, the drive element 212 is designed in a wavy manner over its circumference, so that it forms a stop formation 240. Likewise, the driven element 214 is designed with a corresponding wavy contour in its inner space, so that it forms a counter stop formation 242. The stop formation 240 and the counter stop formation 242 are designed in a manner complementary to one another, that is to say they engage in one another, with an intermediate space which runs all the way round being formed between them. This intermediate space is filled with a rubber layer 244.

The axial sub-region 232 forms a pre-damper, whereas the axial sub-region 234 forms a main damper. In operation, the pre-damper in the sub-region 232 is firstly twisted, so that on a torque transmission the drive element 212 can rotate relative to the driven element 214 about the longitudinal axis A. The main damper has a suitable rotational play for this purpose. The stiffness of the pre-damper is relatively low. When the play provided in the main damper in the axial region 234 is used up, any further relative rotation between the drive part 212 and the driven part 214 can then only take place with torsional deformation both of the pre-damper and the main damper in both axial sub-regions 232 and 234. Thus, again, a stepped progressive characteristic during the damping of torsional vibrations occurs.

It should be noted that the stop formation 240 and the counter stop formation 242 can be produced by roll forming in the exemplary embodiment shown in FIGS. 5 and 6, but also in the exemplary embodiments described above and those still to be explained below.

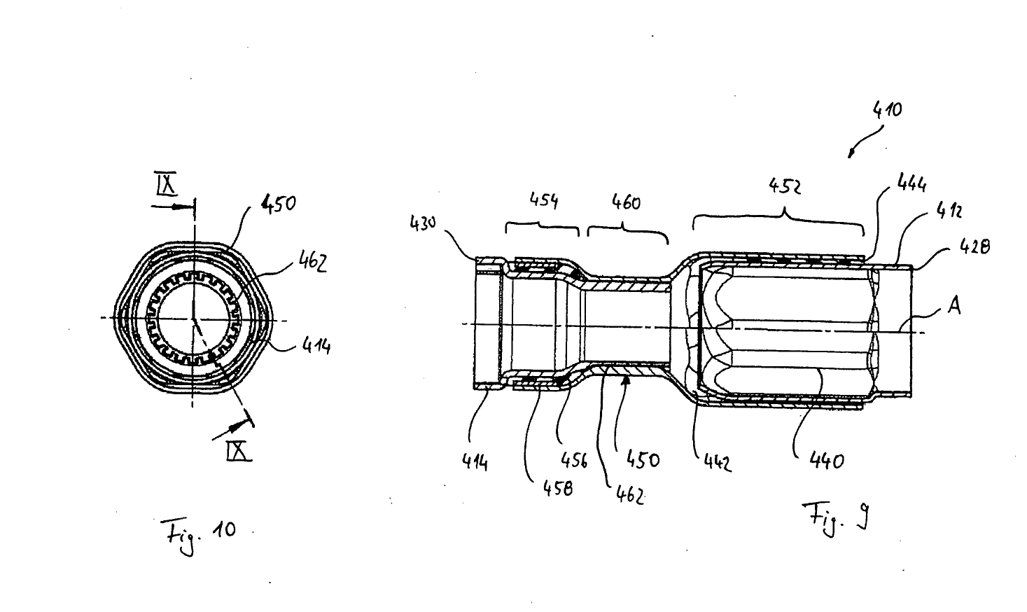

A further embodiment according to FIGS. 7 and 8 is again described using the reference symbols already used above, but prefixed with the numeral “3”.

The embodiment according to FIGS. 7 and 8 differs from the embodiment according to FIGS. 5 and 6 essentially in that the main damper and the pre-damper are not arranged axially next to one another, but that the two dampers are arranged in an axially overlapping relationship. As a result, the two axial regions 232 and 234 can be accommodated in the considerably smaller axial region 316. It can be seen that the drive element 312 is designed in a plurality of parts for this purpose, namely with an outer element 344 and an inner element 346. These two elements are welded together at their contact region at 348. The outer part 344 has the stop formation 340, whereas the inner part 346 is of substantially circular-cylindrical design in the axial region 316. The driven element 314 is embodied as a cast part and is appropriately configured at its left-hand end 330 in FIG. 7 for attachment to a universal joint. In the axial region 316, the driven element 314 has a substantially circular-cylindrical inner circumference, whereas the outer circumferential region is provided with a corresponding counter stop to formation 342. It can be seen that the two rubber bodies 336 and 338 of the pre-damper are arranged between the inner part 346 and the circular-cylindrical inner circumferential surface of the driven element 314. A rubber layer 344 of the main damper is fitted between the stop formation 340 and the counter stop formation 342.

The arrangement behaves as described with reference to FIGS. 5 and 6, that is to say it exhibits a stepped progressive characteristic during the damping of torsional vibrations.

In the event of a crash, this arrangement is also capable of destructive telescoping in the direction of the longitudinal axis A when a predetermined force is exceeded, the driven element 314 being pushed into the drive element 312 and breaking open the connections formed by the two rubber bodies 336 and 338 and also the rubber layer 344. As a result, the length of the drive train can be reduced in a controlled manner.

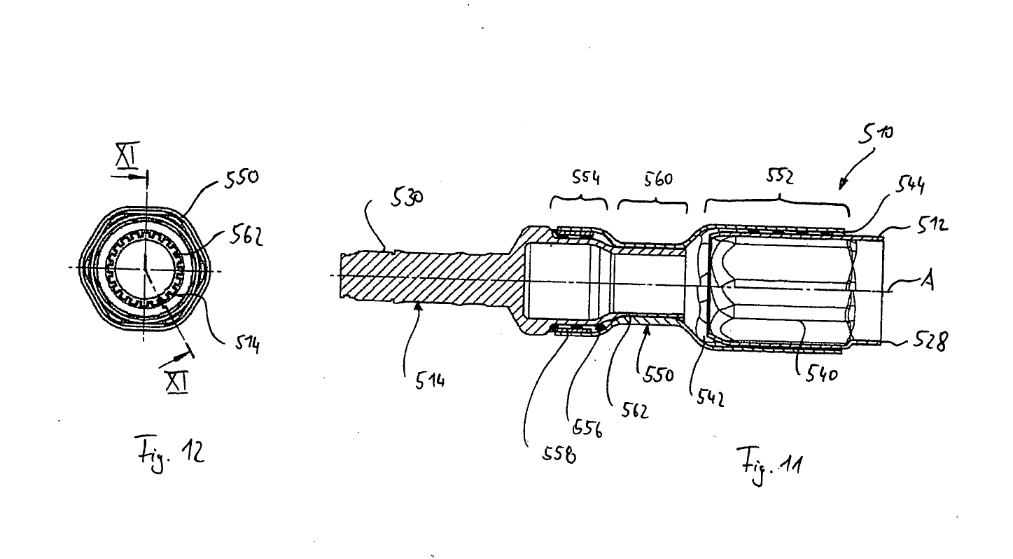

A further exemplary embodiment according to the invention shown in FIGS. 9 and 10 is again described using the reference symbols used in the above-described exemplary embodiments, but prefixed with the numeral “4”.

The special feature of this embodiment consists in that the drive element 412 and the driven element 414 are connected to one another via an intermediate element 450. The drive element 412 is again provided with a stop formation 440. Likewise, the intermediate element 450 is provided with a corresponding counter stop formation 442 in the axial region 452. Formed between these is a rubber layer 444, which constitutes the main damper. In the axial sub-region 454, the intermediate element 450 and the driven element 414 are connected to metal insert 458 via a rubber layer 456 of low, stiffness. Furthermore, it should be pointed out that the intermediate element 450 is connected to the driven element 414 in an axial sub-region 460 by a toothing 462, with play in the circumferential direction.

The torque transmission device 410 also exhibits a stepped progressive characteristic. Firstly, a relative rotation between the intermediate element 450 and the driven element 414 in the region of the rubber layer 456 of relatively low stiffness occurs. Finally, as a result of this relative rotation, the play in the toothing 462 is used up. The rubber layer 444 then allows only a relative rotation between the intermediate element 450 and the driven element 412 with a considerably steeper characteristic, until finally a state of maximum compression occurs in the rubber layer 444, so that a torque transmission takes place via the stop formation 440 and the counter stop formation 442.

In the event of a crash, the arrangement according to FIGS. 9 and 10 is also capable of telescoping, in which case the drive element 412 and the driven element 414 can each be pushed telescopically one into the other and into the intermediate element 450.

It should be mentioned in addition that the stop formation 440 and the counter stop formation 442 are again achieved by corresponding polygonal surfaces, as shown in FIG. 10.

Finally, it should be noted that the embodiment according to FIGS. 9 and 10 is designed for attachment to a cardan shaft by welding the two ends 428 and 430 to corresponding shaft ends.

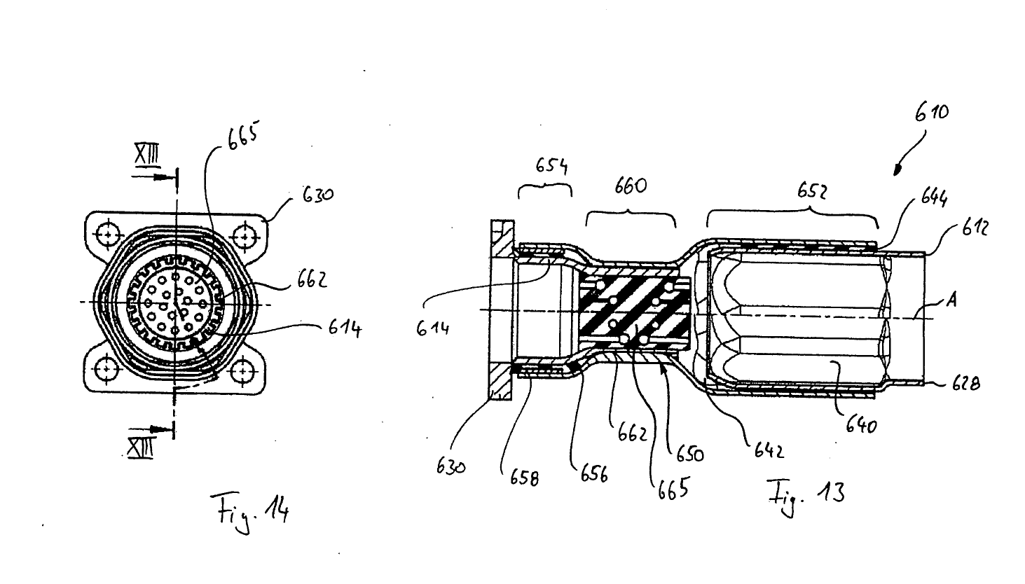

The embodiment according to FIGS. 11 and 12 differs from the embodiment according to FIGS. 9 and 10 merely in that the driven element 514 is designed as a joint bolt for a homokinetic joint.

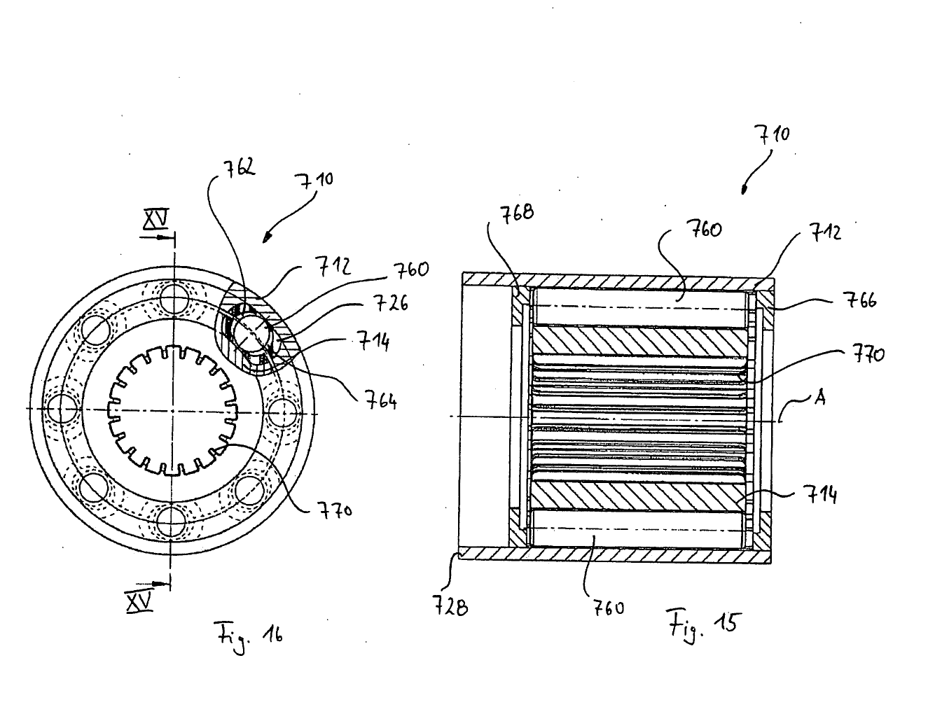

The embodiment according to FIGS. 13 and 14 differs from the embodiment according to FIGS. 9 and 10 essentially in two aspects. On the one hand, the end of the driven element 614 is designed for attachment to a universal joint. On the other hand, in the axial region 660 there is arranged inside the hollow driven element 614 a rubber body 665 which has perforations in the axial direction and transversely thereto. This rubber body 665 serves for the acoustic uncoupling of toothing noises at the toothing 662. The toothing noises which occur as a result of the interaction of the toothing surfaces of the toothing 662 enter the rubber body 665 as structure-borne noise. The structure-borne noise is refracted and reflected at the boundary surfaces of the channels running in the axial direction and transversely thereto. This results in interference and a damping of the noise which occurs, so that the toothing noises are weakened in their intensity.

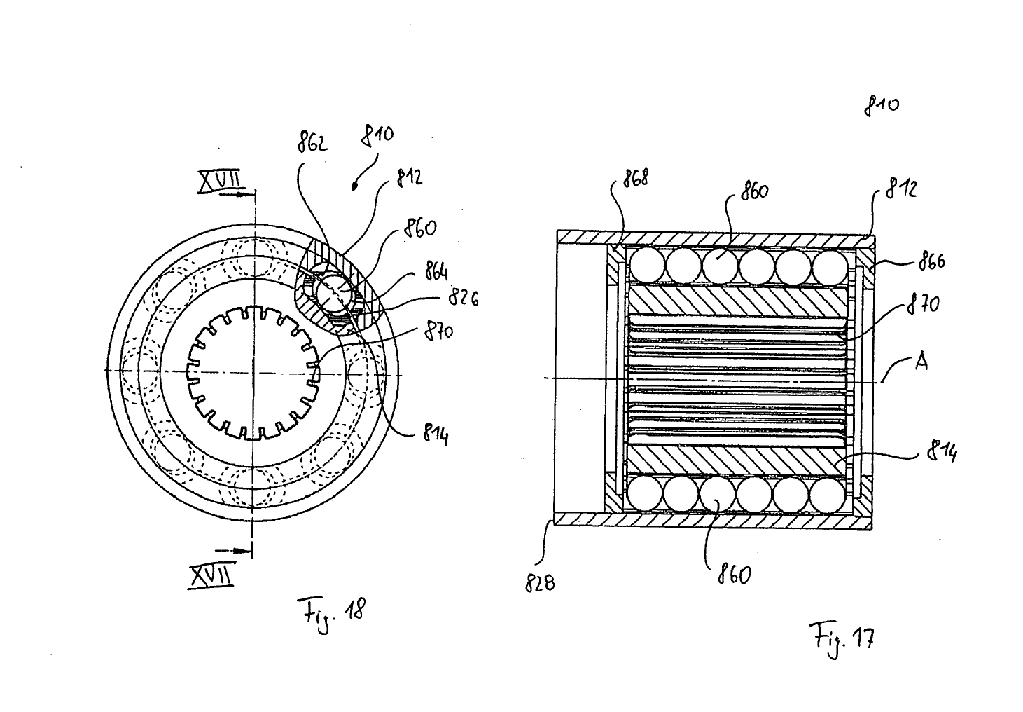

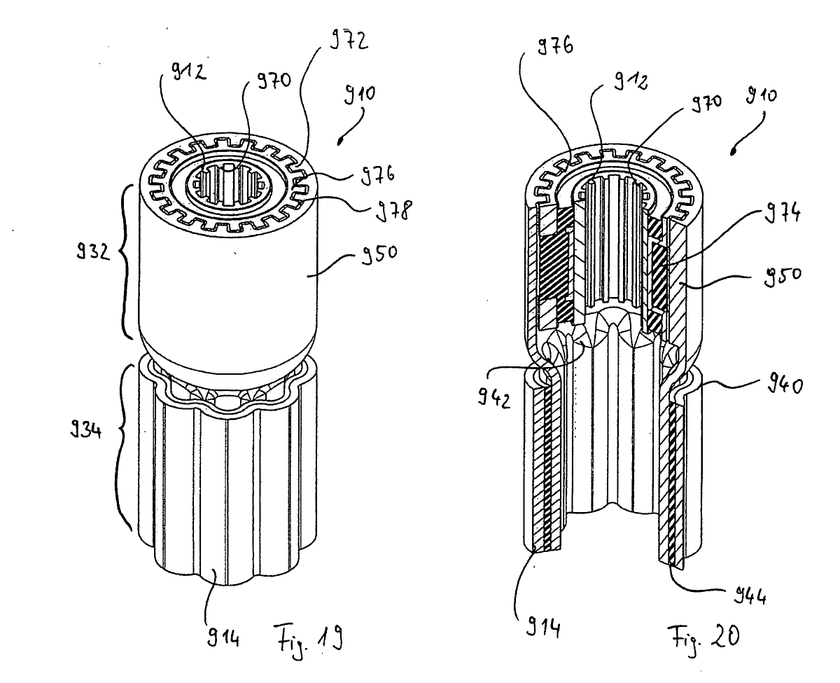

In the embodiment according to FIGS. 15 and 16, the stepped progressive characteristic is not achieved by a pre-damper and main damper, but by the use of rolling contact bodies. The torque transmission device 710 has a drive element 712 and a driven element 714. The driven element 714 is provided with an inner toothing and is arranged inside the tubular drive element 712. The drive element 712 and the driven element 714 are connected to one another by a rubber layer 726 which is formed in an annular intermediate space between them and is vulcanised onto them. Rolling contact rollers 760 are embedded in the rubber layer 726. It will be noted that the rolling contact rollers do not bear directly against the rubber layer 726 in the circumferential direction. Rather, an air-filled crescent-shaped clearance 762 and 764, respectively, is provided in the circumferential direction on both sides of the rollers 760.

The axial position of the driven element 714 relative to the drive element 712 is secured by retaining plates 766 and 768, which are pressed into the tubular drive element 712 with an interference fit.

The drive element 712 can be welded to a shaft at its end 728. The driven element can be connected via a tooth formation 770 to a correspondingly toothed shaft section.

In operation, firstly a relative rotation of drive element 712 and driven element 714 occurs, with the rubber layer 726 being deformed. At the same time, the crescent-shaped intermediate spaces 762 and 764 are also deformed. Such a relative rotation takes place with relatively little resistance. Finally, the rollers 760 come to bear against the boundary surfaces of the rubber layer 726 which define the crescent-shaped intermediate spaces 762 and 764. As soon as such a contact has occurred, a deformation is made considerably more difficult, since the rubber has to be deformed by surface pressure. A stepped progressive characteristic is thus achieved in the course of the relative rotation of drive element 712 and driven element 714.

Furthermore, the crash function which has already been described several times above is also provided for. If an axial loading of the torque transmission device 710 occurs, with a defined minimum force being exceeded, the retaining plates 766 are pushed out of the drive element 712 with their interference fit being overcome, so that the driven element 714 can be displaced relative to the drive element 712 with destruction of the rubber layer 726. A telescopic collapsing of the drive train can thus be achieved, as already described.

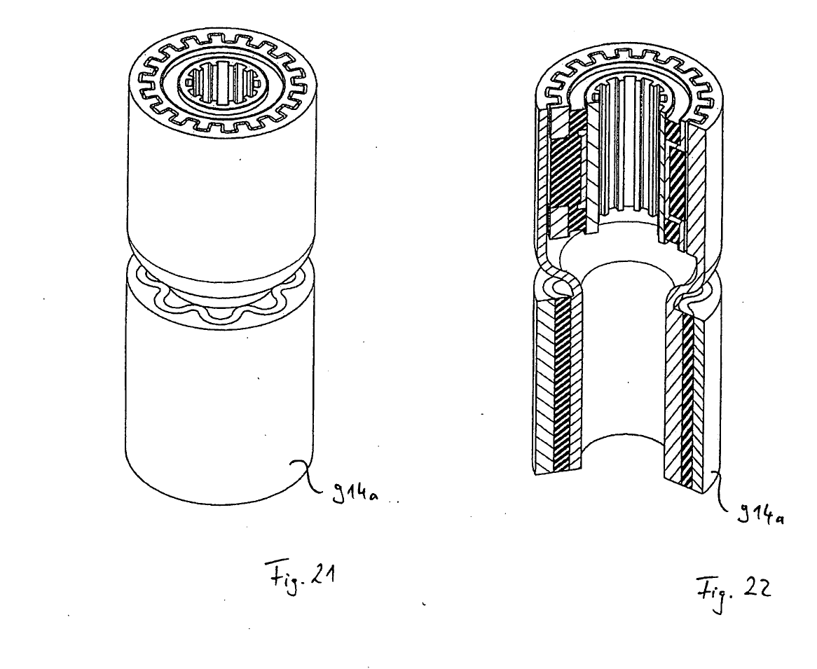

The embodiment according to FIGS. 17 and 18 differs from the embodiment according to FIGS. 15 and 16 merely in that the rollers 760 have been replaced by spherical rolling contact bodies 860 which are arranged in a row but embedded in a corresponding manner in the rubber layer 826 with formation of crescent-shaped intermediate spaces 862 and 864 on both sides of the rolling contact bodies 860 in the circumferential direction. The construction and functioning are otherwise identical to the description with reference to FIGS. 15 and 16.

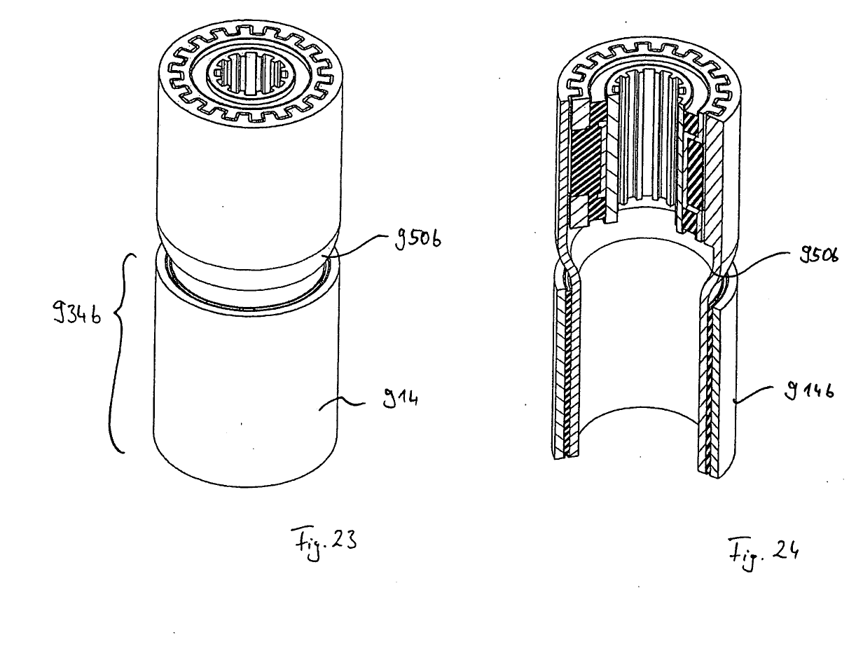

FIGS. 19 and 20 show a further embodiment according to the invention of a torque transmission device 910, FIG. 19 showing a perspective general view and FIG. 20 showing a cutaway representation.

A drive element 912 is provided with an internal toothing 970, by which it can be coupled to a shaft. Vulcanised onto the outer circumference of the drive element 912 is a vibration-damping rubber layer 974, in which a metal insert 976 is embedded. The rubber layer 974 is furthermore vulcanised onto the inner circumference of an intermediate element 950. The intermediate element 950 and the metal insert 976 are in engagement with rotational play via interengaging toothings 972 and 978, but can rotate relative to one another within the limits of the rotational play.

The intermediate element 950 extends from the axial sub-region 932, in which it receives the drive element 912, into an axial sub-region 934, in which it is received by a driven element 914. In the axial sub-region 934, intermediate element 950 and driven element 914 are designed with a stop formation 940 and a counter stop formation 942. A rubber-elastic damping layer 944 is provided between the intermediate element 950 and the driven element 914 in the axial sub-region 934. Accordingly, the pre-damper is arranged in the axial sub-region 932, whereas the main damper is formed in the axial sub-region 934. The functioning is comparable to the functioning of the exemplary embodiment according to FIGS. 9 and 10, although the construction is even more compact.

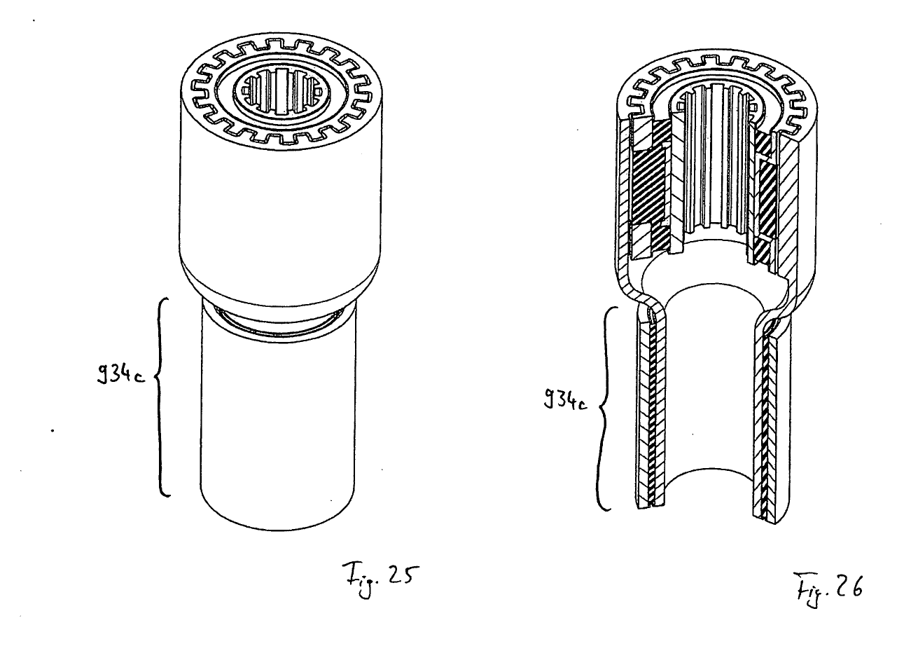

The embodiment according to FIGS. 21 and 22 differs from the embodiment according to FIGS. 19 and 20 merely in that the driven element 914a therein is designed not in a wavy manner but with a circular-cylindrical outer circumference. The construction is otherwise identical. The functioning is comparable to the functioning of the exemplary embodiment according to FIGS. 9 and 10, although the construction is even more compact.

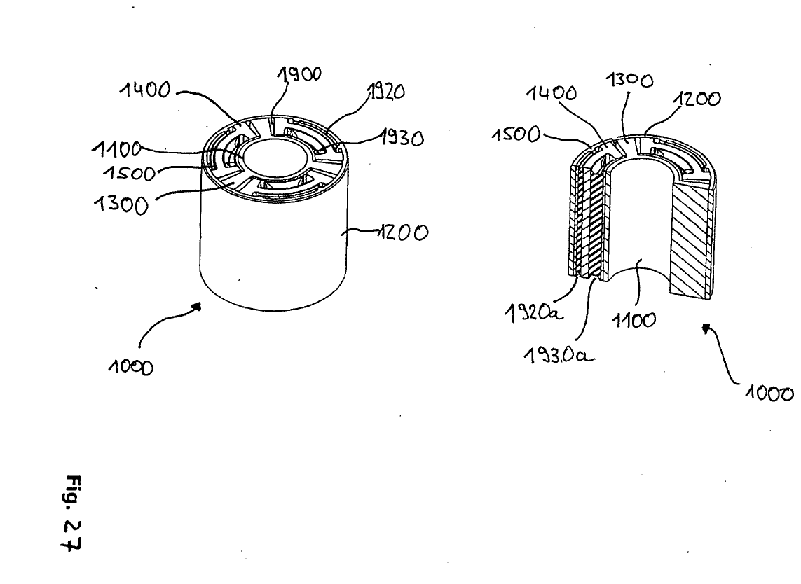

The embodiment according to FIGS. 23 and 24 differs from the embodiment according to FIGS. 19 and 20 merely in that the axial region 934b is of circular-cylindrical design without stop formation and counter stop formation both at the intermediate element 950b and at the driven element 914. The construction is otherwise identical. The functioning is comparable to the functioning of the exemplary embodiment according to FIGS. 9 and 10, although the construction is even more compact.

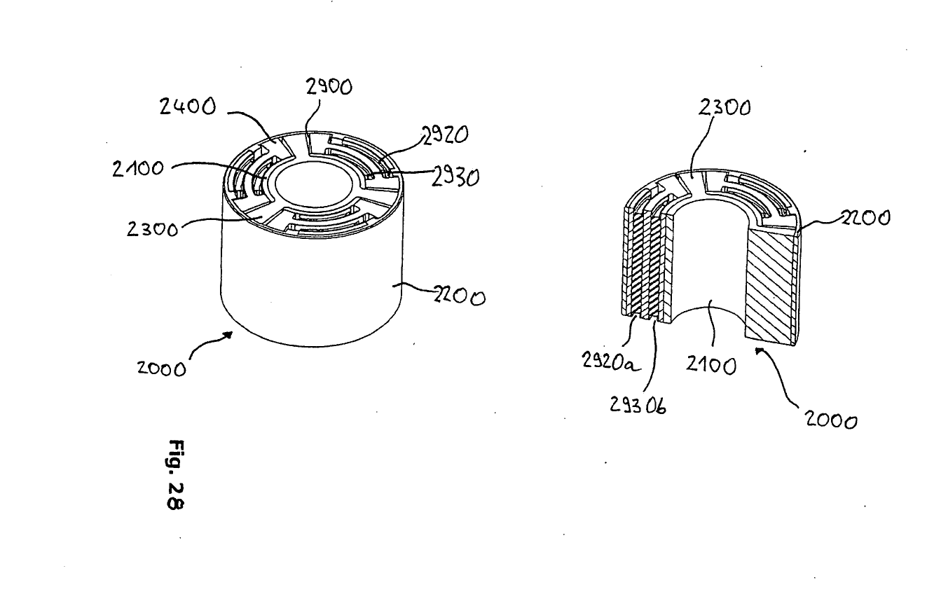

The construction according to FIGS. 25 and 26 differs from the embodiment according to FIGS. 23 and 24 merely in that the axial region 934c is designed with reduced diameter. The construction is otherwise identical. The functioning is comparable to the functioning of the exemplary embodiment according to FIGS. 9 and 10, although the construction is even more compact.

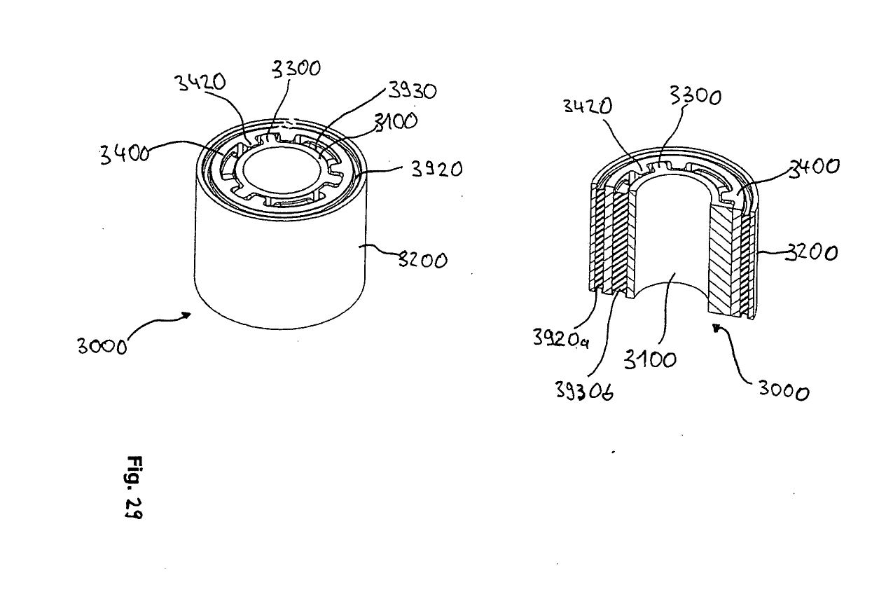

In FIG. 27 to FIG. 30, four further embodiments of a torque transmission device are illustrated. In all of the illustrations 27 to 30, the last three numerals of the reference symbols indicate identical or functionally similar components of the torque transmission devices described here. The first numeral indicates the respective embodiment. The left-hand illustrations in FIG. 27 to FIG. 30 each show a perspective view of the torque transmission devices, while the right-hand illustrations show partially sectioned views thereof. The description of the components of the respective embodiments is followed by a brief description of, the functioning thereof.

The torque transmission device 1000 of FIG. 27 comprises a cylindrically designed drive element 1100 and a cylindrically designed driven element 1200 arranged coaxially therewith, these elements being rotatable about a common axis of rotation. Furthermore, the drive element 1100 has projections 1300 running outwards in the radial direction (three radial ribs are shown), which are arranged at equal angular distances along the circumference of the drive element 1100 and bear in a form-fitting manner against the radially inner surface of the driven element 1200. An intermediate element 1400 is provided in a manner rotationally movable about the axis of rotation between the drive element 1100 and the driven element 1200. In the embodiment illustrated in FIG. 27, three intermediate elements 1400 are arranged almost equidistantly in the circumferential direction.

The intermediate element 1400 defines between the drive element 1100 and the driven element 1200 circular-arc-shaped intermediate spaces 1920, 1930, in which elastic rubber parts 1920a, 1930a are accommodated. The intermediate element 1400 is designed as a curved H-shaped profile and has a length of approximately n/2. Furthermore, an intermediate space 1900 is defined between the ends of the intermediate element 1400 and the projections 1300 of the drive element 1100 which run outwards in the radial direction. In addition, radially inwardly projecting stops 1500 are arranged on the driven element 1200 inside the intermediate space 1920, these stops limiting the rotational movability of the intermediate element 1400. The rotational movability of the intermediate element 1400 is preferably limited to 1-3°.

As can be seen in the right-hand illustration of FIG. 27, the rubber parts 1920a, 1930a completely fill the intermediate spaces 1920, 1930. However, a complete filling of these intermediate spaces 1920, 1930 is not necessary. What is important is merely that the rubber parts 1920a, 1930a couple the intermediate part 1400 in each case to the drive element 1100 and the driven element 1200. For this purpose, the rubber part 1920a bears in a frictionally engaged manner against the intermediate element 1400 in the region of the intermediate space 1920 and against the driven element 1200, and the rubber part 1930a bears in a frictionally engaged manner against the intermediate element 1400 in the region of the intermediate space 1930 and against the drive element 1100. In this embodiment, the hardness of the rubber part 1930a is less than that of the rubber part 1920a.

If the drive element 1100 is now attached to a shaft (not illustrated), the rotational movement of the shaft is transmitted with the aid of the torque transmission device 1000 to a hub (not illustrated) attached to the driven element 1200. On the transmission of the rotational movement, the drive element 1100 firstly moves relative to the driven element 1200. During this relative movement, the rubber part 1930a is sheared (twisted) until the projection 1300 strikes the intermediate part 1400. Simultaneously, the rubber part 1920a is subjected to shearing. In the case where the hardness (shearing ability) of the rubber part 1930a is markedly less than the hardness of the rubber part 1920a, it may happen that the projection 1300 strikes the intermediate part 1400 before the rubber part 1920a has undergone significant shearing. If the projection 1300 now bears against the intermediate part 1400 and if the drive element 1100, and thus the projection 1300, is rotated further relative to the driven element 1200, the extent of the shearing of the rubber part 1930a remains unchanged, i.e. the shearing of the rubber part 1930a is “frozen”. The rubber part 1920a is further sheared until the end of the H-shaped intermediate part 1400 strikes the stop 1500.

In contrast to the embodiment illustrated in FIG. 27, the torque transmission device 2000 illustrated in FIG. 28 has essentially the same construction, but with the difference that the axial width (thickness) of the rubber part 2920a (corresponds to the rubber part 1920a of FIG. 22) is increased and here is equal to the axial width (thickness) of the rubber part 2930a (corresponds to the rubber part 1930a of FIG. 27). By changing the width of the rubber part 2920a, its shearing ability (resistance to shearing) is thereby reduced. The rubber part 2920a thus undergoes higher torsion (shearing) than the corresponding rubber part 1920a of FIG. 27 during the rotational movement of the drive element 2100 and of the intermediate part 2400.

By specific selection of the hardness of the rubber parts 1920a, 1930a, 2920a, 2930a and also their width (shape, geometry), the torsional behaviour of the torque transmission device 1000, 2000 can be influenced in a controlled manner. Since the rubber part 1930a, 2930a determines the course of the torsional characteristic in the region of the zero crossing, and this course is to be kept as flat as possible and therefore a relatively soft material is used for the rubber parts 1930a, 2930a, the hardness of the rubber parts 1920a, 2920a determines the torsional characteristic at greater angles of rotation. By selecting a specific hardness for the rubber parts 1920a, 2920a, a correspondingly progressive course of the torsional characteristic can be obtained.

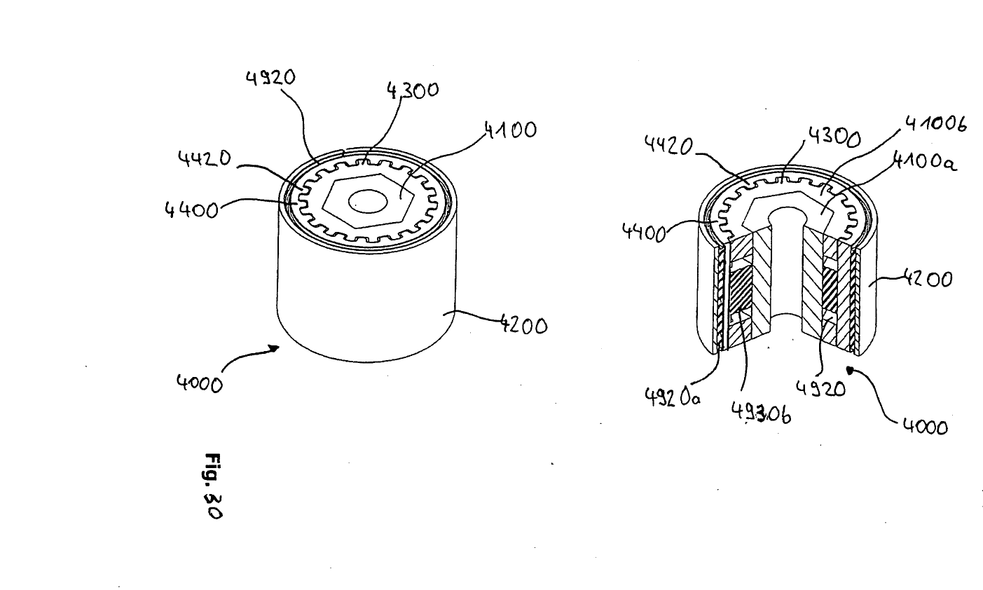

In contrast to the above-described embodiments of FIG. 27 and FIG. 28, the embodiment illustrated in FIG. 29 shows an intermediate part 3400 which is designed to form a closed ring shape. The intermediate part 3400 has projections 3420 which run inwards in the radial direction and can be brought into engagement with the projections 3300 of the drive element 3100 which run outwards in the radial direction. It can thus be seen in FIG. 29 that in each case two projections 3420 of the intermediate part 3400 are arranged in the circumferential direction adjacent to one projection 3300 of the drive element 3100. The projections 3300 are arranged at uniform angular distances from one another along the circumference of the drive part 3100. Referring to the right-hand illustration of FIG. 29, an inner rubber part 3930a is fitted in a frictionally engaged manner between the intermediate part 3400 and the drive part 3100. The embodiment of FIG. 29 comprises three rubber parts 3930a which are fitted into three arcuately shaped intermediate spaces 3930. The outer rubber part 3920a is of closed ring-shaped design and is accommodated in a frictionally engaged manner in the closed cylindrical intermediate space 3920 between the driven element 3200 and the intermediate part 3400.

If the drive element 3100 is rotated relative to the driven element 3200, both rubber parts 3920a, 3930a are sheared. As soon as the projections 3300 strike the projections 3420, the shearing state of the rubber part 3930a is “frozen”. On continued rotation of the drive element 3100, the rubber part 3920a is now further sheared until the shearing resistance of the rubber part 3920a is overcome and the driven element 3200 is set in rotation. Here, too, by specific selection of the hardness of the rubber parts 3920a, 3930a and also their width (thickness), the torsional behaviour (torsional characteristic) of the torque transmission device 3000 can be influenced in a controlled manner.

In contrast to the embodiment shown in FIG. 29, the embodiment of FIG. 30 has an intermediate part 4400 of closed design which can come into interlocking engagement with a drive element 4100a, 4100b. The drive element comprises an element 4100a designed as a hexagon on the outside and cylindrically on the inside. Annularly closed elements 4100b are attached to the axial ends of the element 4100a. At their radially outer circumference, the elements 4100b have projections 4300 which are arranged at equal angular distances. The hexagon illustrated in FIG. 30 serves for easier mounting of the end-side end elements 4100b. Owing to the fact that the drive element has projections 4300 arranged at relatively short intervals equidistantly in the circumferential direction, the rubber part 4930a, which couples the drive part 4100 in a frictionally engaged manner to the intermediate part 4400, is arranged axially centrally in an annularly closed cavity 4920 of the torque transmission device 4400 (see right-hand illustration of FIG. 30). The rubber part 4920a is accommodated in a closed cylindrically designed intermediate space 4920 between the driven element 4200 and the intermediate part 4400.

As can be seen in the right-hand illustration of FIG. 30, the rubber parts 4920a, 4930a have different widths. Furthermore, the frictionally engaged contact of the rubber part 4920a with the intermediate part 4400 is greater than that of the rubber part 4930a. In the embodiment illustrated in FIG. 30, too, the shearing action of the rubber part 4930a determines the course of the torsional characteristic in the region of the zero crossing, while the relatively thinly designed rubber part 4920a enables a progressive torsional characteristic at higher angles of rotation.

The invention according to FIGS. 27 to 30 is based on the fact that the rubber parts 1920a, 1930a-4920a, 4930a spring-elastically couple the intermediate part 1400-4400 in the direction of rotation of the drive element 1100-4100 and of the driven element 1200-4400. Moreover, the rubber parts 1920a, 1930a-4920a, 4930a can spring-elastically couple the drive element and the driven element to the intermediate part in the radial direction.

Furthermore, the function of the drive element can be interchanged with the function of the driven element, i.e. the drive element described here becomes a driven element and the driven element described here becomes a drive element.

It is also conceivable that the spring-elastic function of the rubber parts 1920a, 1930a-4920a, 4930a may be realised by other spring bodies, for example by helical springs, flat spiral springs, etc.

In all of the embodiments described here according to FIGS. 27 to 30, the drive element 1100-4100, the driven element 1200-4200 and the intermediate part 1400-4400 may be produced from a metal, for example aluminium, or a plastic. For the rubber parts 1920a, 1930a-4920a, 4930a, rubber having a Shore hardness in the range from 40 to 80 is preferably used.

Furthermore, the drive element 1100-4100 may be coupled to the intermediate part 1400-4400 in a materially joined manner by the rubber part 1930a-4930a and the driven element 1200-4200.

The intermediate parts 1400-4400 may act as vibration absorbers in all of the embodiments according to FIGS. 27 to 30, since they are mounted between the driven part 1200-4200 and the drive part 1100-4100 in a rotationally movable (“floating”) manner. If vibrations occur in the drive part 1100-4100, the frictionally engaged coupling by means of the rubber element 1930a-4930a enables the intermediate part 1400-4400 to create a vibration in phase opposition to the vibrations. In this case, the intermediate part 1400-4400 acts as a freely movable compensating mass, by which the vibrations of the drive part 1100-4100 are compensated and thus not transmitted to the driven part 1200-4200.

1. A torque transmission device for the vibration-reduced transmission of torques via at least one shaft, having:
a drive element and a driven element connected to the drive element, there being formed between the drive element and the driven element at least one damping arrangement which connects the drive element to the driven element such that they can rotate relative to one another, the damping arrangement having a stepped progressive characteristic with increasing relative rotation between drive element and driven element.

2. The torque transmission device according to claim 1, characterised in that the drive element has a stop formation and in that the driven element has a complementary counter stop formation, the stop formation and the counter stop formation engaging one in the other with mutual radial play and rotational play.

3. The torque transmission device according to claim 2, characterised in that the stop formation and the counter stop formation are designed in the form of a splining with play.

4. The torque transmission device according to claim 2, characterised in that the stop formation and the counter stop formation are designed in the form of a polygonal form-fitting connection with play.

5. The torque transmission device according to one of claims 2 to 4, characterised in that a compressible damping layer made of rubber material is provided between the stop formation and the counter stop formation.

6. The torque transmission device according to claim 5, characterised in that a thread insert is embedded in the rubber layer.

7. The torque transmission device according to claim 5, characterised in that a metal insert is embedded in the rubber layer.

8. The torque transmission device according to one of claims 1 to 4, characterised in that at least one rubber-elastic pre-damper body is provided between the drive element and the driven element outside the cooperating stop formation and counter stop formation, which body connects the drive element to the driven body in a torsional-vibration-damping manner.

9. The torque transmission device according to claim 1, characterised in that an intermediate element is arranged between the drive element and the driven element, the intermediate element being connected in a tubular manner to the drive element and the driven element with respective interposition of a damping arrangement.

10. The torque transmission device according to claim 9, characterised in that the intermediate element is connected, one behind the other when seen in the axial direction, to the drive element and the driven element, the drive element not overlapping the driven element.

11. The torque transmission device according to claim 9 or 10, characterised in that the drive element or/and the driven element have a stop formation and in that the intermediate element has a complementary counter stop formation in its respective region cooperating with the drive element and the driven element, the stop formation and the counter stop formation each engaging one in the other with mutual radial play and rotational play.

12. The torque transmission device according to one of claim 9 or 10, characterised in that the intermediate element is of tubular design and receives the drive element at one end and the driven element at the other end.

13. The torque transmission device according to claim 1 or claim 9, characterised in that a perforated rubber body for damping structure-borne noise is received in the drive element or/and in the driven element or/and in the intermediate element.

14. The torque transmission device according to claim 1 or claim 9, characterised in that one component of drive element and driven element is designed for attachment to a shaft end and in that the other component of drive element and driven element is designed for attachment to a jointed tube or a homokinetic joint or to a universal joint.

15. The torque transmission device according to claim 1 or claim 9, characterised in that a rubber-elastic damping layer is provided between the drive element and the driven element and connects the drive element to the driven element, rolling contact bodies being embedded in the damping layer.

16. The torque transmission device according to claim 15, characterised in that the rubber-elastic damping layer provides, in the region of the rolling contact bodies, a play in relation to the respective rolling contact body when seen in the circumferential direction of the torque transmission device.

17. The torque transmission device according to claim 1 or claim 9, characterised in that the drive element and the driven element are capable of telescoping in the axial direction with respect to one another when a predetermined axial force is exceeded.

18. A torque transmission device (1000) for coupling shafts, having:
an outer driven element (1200) and an inner drive element (1100), arranged inside the driven element (1200) and rotationally movable relative to the driven element (1200), and an intermediate element (1400) arranged rotationally movably between the drive element (1100) and the driven element (1200), the intermediate element (1400) being coupled in a frictionally engaged manner to the drive element (1100) via a first coupling part (1930a) and to the driven element (1200) via a second coupling part (1920a).

19. The torque transmission device (1000) according to claim 18, in which the rotational movability of the intermediate element (1400) is limited by at least one stop (1500) arranged on the driven element (1200).

20. The torque transmission device (1000) according to claim 18 or 19, in which the drive element (1100) has at least one projection (1300) which runs outwards in the radial direction and can be brought into engagement with the intermediate element (1400).

21. The torque transmission device (1000) according to claim 18 or 19, in which the drive element (1100) has a multiplicity of projections (1300) which run outwards in the radial direction and are arranged at equal angular distances along a circumference of the drive part (1100).

22. The torque transmission device (1000) according to claim 18 or 19, in which the drive part (1100) can be brought into interlocking engagement with the intermediate part (1400).

23. The torque transmission device (1000) according to claim 18 or 19, in which the first coupling part (1930a) and the second coupling part (1920a) are elastic rubber parts.

24. The torque transmission device (1000) according to claim 23, in which the elastic rubber part of the first coupling part (1930a) and the elastic rubber part of the second coupling part have different Shore hardnesses.

25. The torque transmission device (1000) according to claim 23, in which the Shore hardness of the first coupling part (1930a) is less than the Shore hardness of the second coupling part (1920a).

26. The torque transmission device (1000) according to claim 18 or 19, in which the first coupling part (1930a) and the second coupling part (1920a) have different widths in an axial and/or radial cross-section.

27. The torque transmission device (1000) according to claim 18 or 19, in which the intermediate element (1400) is coupled in a materially joined manner to the drive element (1100) via the first coupling part (1930a) and to the driven element (1200) via the second coupling part (1920a).
